(19) United States
(12) Patent Application Publication
(10) Pub. No.: US 2024/0070760 A1
(43) Pub. Date: Feb. 29, 2024

(54) INFORMATION PROCESSING APPARATUS, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Takuma YAMAMOTO, Kanagawa (JP)

(73) Assignee: FUJIFILM Business Innovation Corp., Tokyo (JP)

(21) Appl. No.: 18/178,571

(22) Filed: Mar. 6, 2023

(30) Foreign Application Priority Data
Aug. 24, 2022 (JP) 2022-132892

(51) Int. Cl. G06Q 30/0601; G06V 10/20

(52) U.S. Cl. CPC G06Q 30/0639; G06Q 30/0627; G06V 10/255

(57) ABSTRACT

An information processing apparatus includes a processor configured to: obtain an image provided from a user; identify an article in the image; and exert control to display arrangement-related information useful for arranging the identified article.

### CROSS-REFERENCE TO RELATED APPLICATIONS

This application is based on and claims priority under 35 USC 119 from Japanese Patent Application No. 2022-132892 filed Aug. 24, 2022.

### BACKGROUND

### (i) Technical Field

The present disclosure relates to an information processing apparatus, a non-transitory computer readable medium, and an information processing method.

### (ii) Related Art

In recent years, purchase of items for sale, not at real shops, but in Internet shopping, that is, through the Internet, has become popular. As a method of searching for an item for sale which a user wants to purchase through the Internet, the following technique has been proposed in the related art: when the size of an area of a location, in which the item is to be placed and which is photographed by a user by using a camera of a terminal, is received, the user is provided with information about items for sale, each of which is accommodated in the area, from information about multiple items for sale (see Japanese Unexamined Patent Application Publication No. 2021-009495).

In the related art, items for sale, each of which is appropriate for an area photographed by a user, are proposed. However, the user may want to know, not items for sale, each of which is accommodated in the area, but information useful for arranging an article(s) in a captured image.

### SUMMARY

Aspects of non-limiting embodiments of the present disclosure relate to a technique for providing, to a user, information useful for arranging an article(s) in an image.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus comprising a processor configured to: obtain an image provided from a user; identify an article in the image; and exert control to display arrangement-related information useful for arranging the identified article.

### BRIEF DESCRIPTION OF THE DRAWINGS

Exemplary embodiment of the present disclosure will be described in detail based on the following figures, wherein:

FIG. 1 is a diagram illustrating an example of the entire schematic configuration of a service system and the block configuration of each information processing apparatus, according to the present exemplary embodiment;

FIG. 2 is a diagram illustrating an exemplary data configuration of article-image information according to the present exemplary embodiment;

FIG. 3 is a diagram illustrating an exemplary data configuration of item-for-sale information according to the present exemplary embodiment;

FIG. 4 is a diagram illustrating an exemplary data configuration of storage-location image information according to the present exemplary embodiment;

FIG. 5A is a flowchart of a search service process according to the present exemplary embodiment;

FIG. 5B is a flowchart continuing from FIG. 5A; and

FIGS. 6A to 6F are diagrams illustrating a screen transition of a user terminal in a user's use of a search service, according to the present exemplary embodiment.

### DETAILED DESCRIPTION

An exemplary embodiment of the present disclosure will be described below on the basis of the drawings.

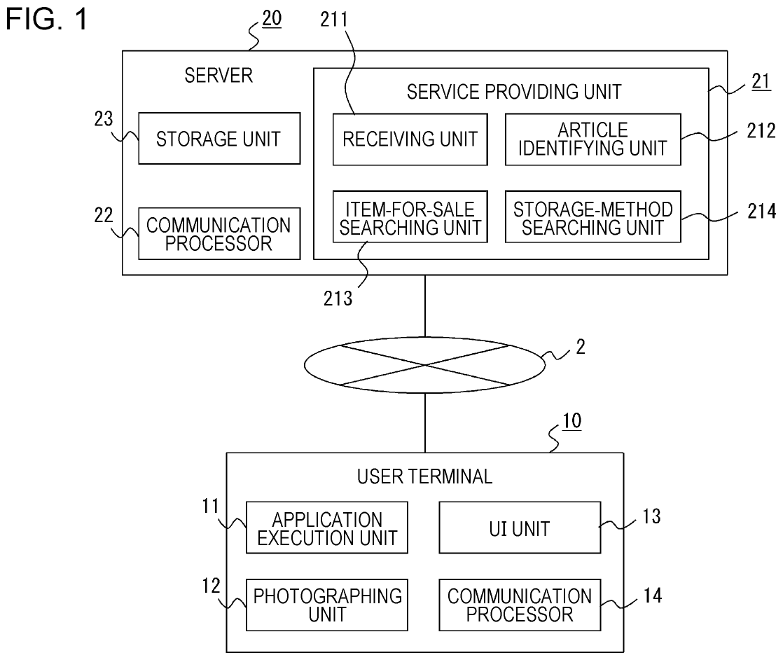

FIG. 1 is a diagram illustrating an example of the entire schematic configuration of a service system and the block configurations of a user terminal 10 and a server 20, according to the present exemplary embodiment. FIG. 1 illustrates a system configuration in which the user terminal 10 is connected to the server 20 over a network 2 such as the Internet. The user terminal 10 is a form of an information processing apparatus used by a user of a search service provided by the server 20. The server 20 is a server computer which provides the search service to a user who uses the user terminal 10. Multiple users, who use the search service, use their user terminals 10 having equivalent functions. Thus, for the sake of convenience, FIG. 1 illustrates only one user terminal 10.

The server 20 may be implemented by using a hardware configuration of an existing general-purpose server computer. That is, the server 20 includes, for example, a central processing unit (CPU), a read-only memory (ROM), a random-access memory (RAM), a hard disk drive as a storage unit, and a network interface as a communication unit. The server 20 is an exemplary information processing apparatus provided by the present disclosure. FIG. 1 illustrates the server 20 as a single server computer. For example, the server 20 may be implemented by using a combination of multiple computers which are present on clouds.

The server 20 includes a service providing unit 21, a communication processor 22, and a storage unit 23. Components which are not used in the description about the present exemplary embodiment are not illustrated. The service providing unit 21 provides the search service in response to a search request from a user. The communication processor 22 communicates with the user terminal 10 over the network 2. The storage unit 23 stores information necessary to run the search service. In the present exemplary embodiment, the storage unit 23 stores article-image information, item-for-sale image information, and storage-location image information.

The service providing unit 21 includes a receiving unit 211, an article identifying unit 212, an item-for-sale searching unit 213, and a storage-method searching unit 214. The receiving unit 211 receives a search request from the user terminal 10, that is, a message that use of the search service is to be started. The receiving unit 211 obtains information, such as images and a search target, which is transmitted from the user terminal 10. The article identifying unit 212 analyzes an image transmitted on transmission of a request for a search, and thus identifies an article in the image. In the search service, a search is performed on the basis of the identified article. Thus, arrangement-related information, which is useful for arranging the identified article, is obtained and provided to the user. To do this, the item-for-sale searching unit 213 performs a search on the basis of the identified article, and thus obtains, as arrangement-related information, information about items for sale which are used to arrange the article. The storage-method searching unit 214 performs a search on the basis of the identified article, and thus obtains, as arrangement-related information, information about a storage method.

An image, which is obtained by the receiving unit 211 on reception of a search request, includes an image of an article which is a target that is to be arranged. “To arrange things” is defined, for example, as “to arrange things that are in a disordered state”. In the present exemplary embodiment, “to arrange things” is used as a synonym of “to put things in order” which is used as a typical expression. There may be various methods of putting articles in order, such as storing the articles in a product, such as a storage rack or a storage box, which may accommodate the articles, hanging the articles on hooks and the like, and placing the articles, as they are, in a space. “To arrange things” in the present exemplary embodiment encompasses all methods of putting articles in order. In the description below, unless otherwise specified, a method of arranging articles will be described by taking, as an example, the case in which an article is “stored” in some product and the product is “stored” in a location which may accommodate the product. In the present exemplary embodiment, a product used for storage of an article will be described by taking, as an example, the case in which the product is an item for sale which is sold somewhere. Therefore, in the present exemplary embodiment, “product” is a synonym of “item for sale”. In the description below, “item for sale” is used.

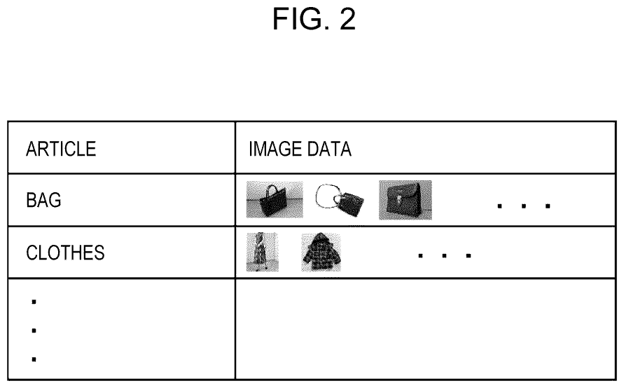

FIG. 2 is a diagram illustrating an exemplary data configuration of article-image information according to the present exemplary embodiment. The article-image information includes “article” and “image data” which are associated with each other. “Article” indicates information for identifying the corresponding article. In the present exemplary embodiment, “article” indicates the name of the corresponding article. “Image data” indicates image data used to identify an article in an image transmitted from a user. To identify an article in an image with a high accuracy, image data of various articles may be included in “image data”.

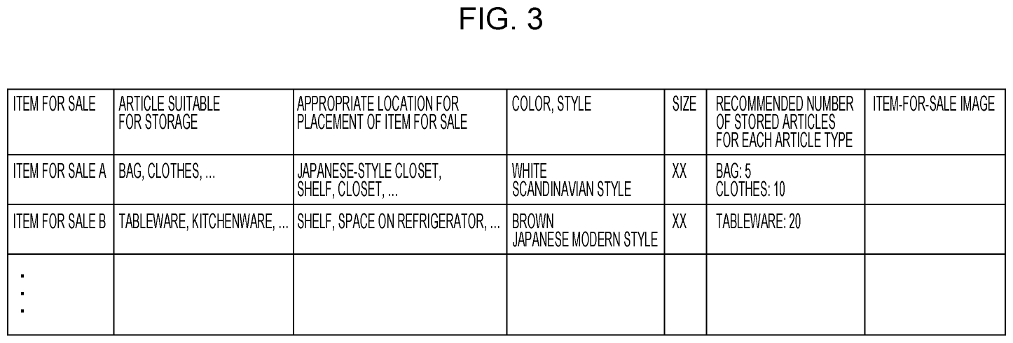

FIG. 3 is a diagram illustrating an exemplary data configuration of item-for-sale information according to the present exemplary embodiment. The item-for-sale information is information about items for sale which may be used to store an article. The item-for-sale information includes “item for sale” and informational fields indicating the specification and features of the corresponding item for sale. In a search for an item for sale, the item-for-sale searching unit 213 refers to the informational fields, which are described below, from the items for sale which are registered in the item-for-sale information, and extracts items for sale which are appropriate for storage of an article in an image. In the present exemplary embodiment, the informational fields include “article suitable for storage”, “appropriate location for placement of item for sale”, “color, style”, “size”, “recommended number of stored articles for each article type”, and “item-for-sale image”. “Item for sale” indicates information for identifying the corresponding item for sale. In the present exemplary embodiment, “item for sale” indicates the name of the item for sale. However, items for sale having the same name may have different specifications, for example, in color, size, material, and/or gradation of quality. Thus, if such items for sale have different specifications, they may be registered in the item-for-sale information as different items for sale. In “article suitable for storage”, the names of one or more articles, which are appropriate for storage in the corresponding item for sale, are set. In “appropriate location for placement of item for sale”, one or more locations, which are appropriate for placement of the corresponding item for sale, are set. In “color, style”, for example, words, which indicate the specification such as the color of the corresponding item for sale, and the features of its appearance, are set. In “size”, information indicating the size and shape of the corresponding item for sale is set. “Size” has a different setting depending on the shape of an item for sale. For example, if the item for sale has a box shape, the height, the width, the depth, and the like of the item for sale are set. In “recommended number of stored articles for each article type”, the recommended number of stored articles, which are accommodated in the corresponding item for sale, is set. For example, when the item for sale has multiple framed spaces separated from each other, “recommended number of stored articles for each article type” indicates the number of framed spaces. In “recommended number of stored articles for each article type”, for each article type appearing in images, the recommended number of stored articles of the type is set. As a matter of course, if articles of a type have different sizes, the recommended number of articles is different by a large extent depending on their size. In contrast, for a type of articles whose sizes are within a certain degree, “recommended number of stored articles for each article type” may be useful information for selection of an item for sale. In “item-for-sale image”, image data of the corresponding item for sale is stored. The storage location of the image data may be set in “item-for-sale image”.

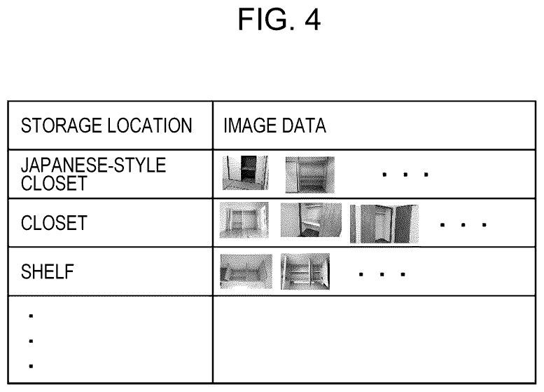

FIG. 4 is a diagram illustrating an exemplary data configuration of storage-location image information according to the present exemplary embodiment. The storage-location image information is information about each location which may be a storage location for an item for sale. The storage-location image information includes “storage location” and “image data” which are associated with each other. “Storage location” indicates information for identifying the corresponding storage location. In the present exemplary embodiment, “storage location” indicates the name of the corresponding location. “Image data” indicates image data used to identify a storage location photographed by a user. To identify a storage location with a high accuracy, image data of various storage locations may be included in “image data”.

The components 21 to 22 of the server 20 are implemented through collaborative operations between the computer forming the server 20 and programs executed by the CPU included in the computer. The storage unit 23 is implemented by using a hard disk drive (HDD) included in the server 20. Alternatively, the RAM may be used, or an external storage unit may be used over a network.

The user terminal 10 may be implemented by using the hardware configuration of a general-purpose portable terminal apparatus, such as a smartphone, including a camera. That is, the user terminal 10 includes a CPU, a ROM, a RAM, a storage as a storage unit, a network interface as a communication unit, a touch panel as a user interface, and a camera. In the present exemplary embodiment, the case in which a user photographs an article or the like by themselves is assumed. Thus, the user terminal 10 needs to be a camera-mounted device. However, when a user uses, not a photographic image generated by the user taking a photograph by themselves in use of the search service, but an image, such as an existing image captured by the user by using another device, an existing image captured by another person taking a photograph, or a screen shot, the user terminal 10 may be implemented by using, for example, a personal computer having no camera.

The user terminal 10 includes an application execution unit 11, a photographing unit 12, a user interface (UI) unit 13, and a communication processor 14. Components which are not used in the description about the present exemplary embodiment are not illustrated. The application execution unit 11 executes an application, which is installed in the user terminal 10, to use the search service provided by the server 20. The photographing unit 12 photographs an article or the like in collaboration with the camera included in the user terminal 10, and generates a photographic image. The user interface unit 13 receives information which is input by a user on the touch panel in use of the search service provided by the server 20, and displays a search result or the like on the touch panel. The communication processor 14 communicates with the server 20 over the network 2.

The components 11 to 14 of the user terminal 10 are implemented through collaborative operations between the computer included in the user terminal 10 and programs executed by the CPU included in the computer.

The programs used in the present exemplary embodiment may be provided, not only through a communication unit, but also through storage in a computer-readable recording medium such as a Universal Serial Bus (USB) memory. The programs provided through a communication unit or a recording medium are installed in a computer. The CPU of the computer executes the programs sequentially to implement various processes.

Operations according to the present exemplary embodiment will be described.

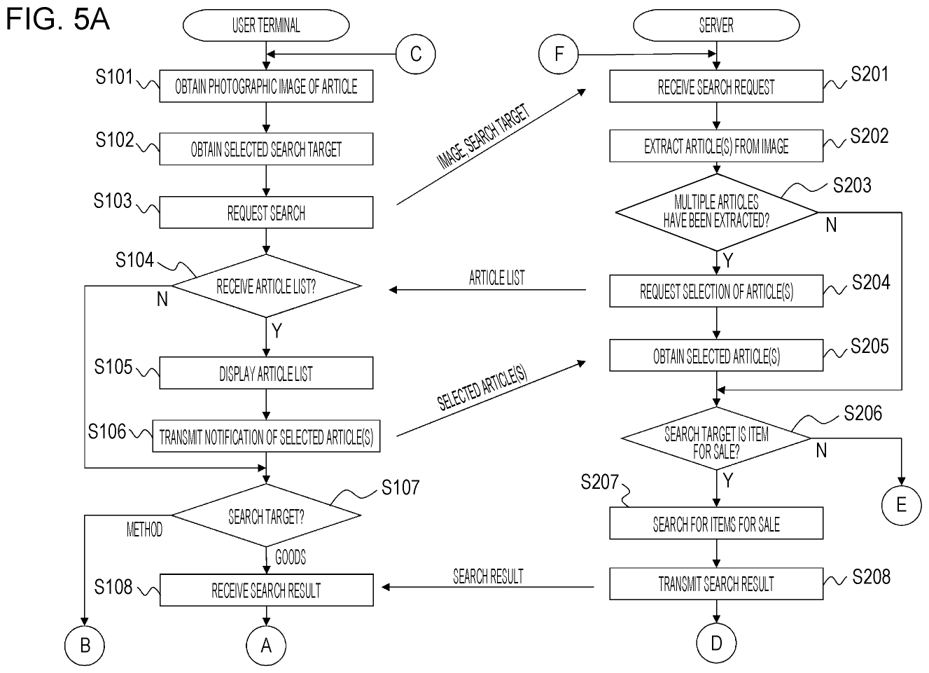

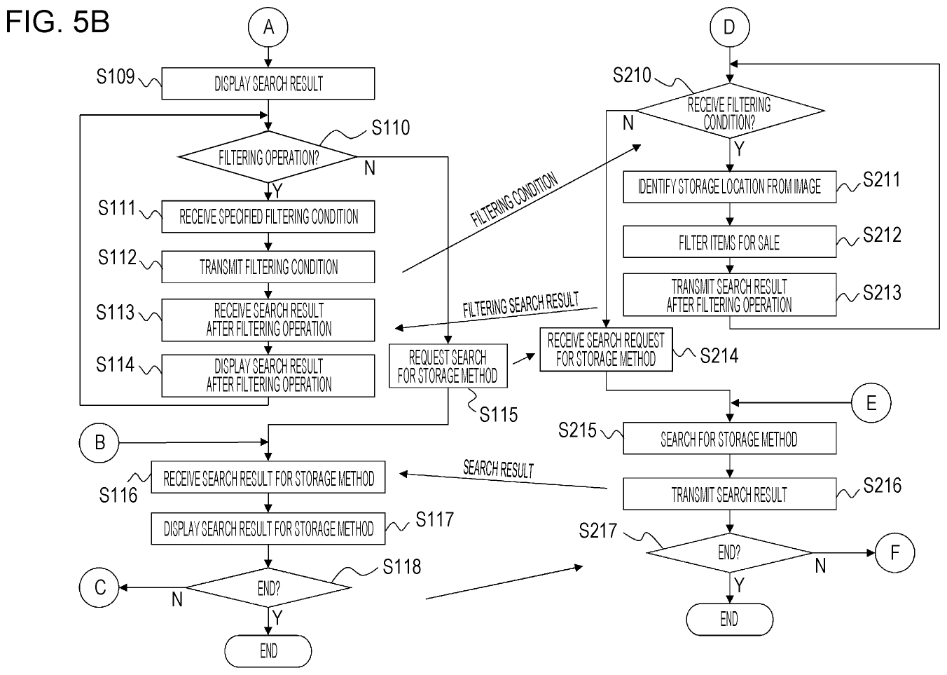

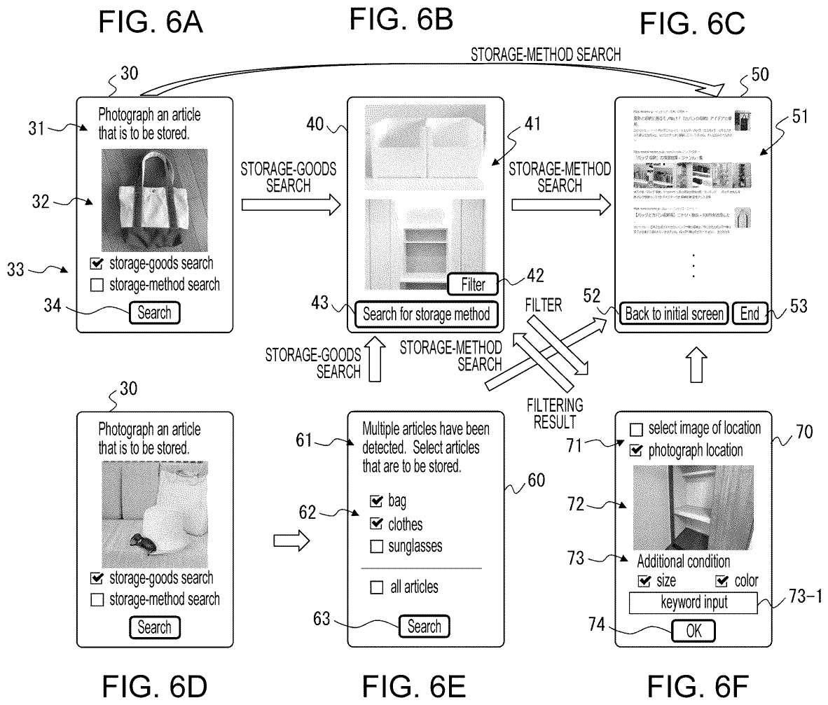

In the present exemplary embodiment, a user may start a predetermined application to start use of the search service. FIGS. 5A and 5B are flowcharts of processes performed in use of the search service, according to the present exemplary embodiment. FIGS. 6A to 6F are diagrams illustrating a screen transition of the user terminal 10 in use of the search service. The search service according to the present exemplary embodiment will be described below by using these figures.

When a user starts the predetermined application, the application execution unit 11 starts execution of the started application. The application displays an initial screen 30, which is illustrated in FIG. 6A, on the touch panel in collaboration with the service providing unit 21 of the server 20. The screen data of a screen displayed on the touch panel of the user terminal 10 may be obtained from the server 20 every time the screen is to be displayed. Alternatively, the image data may be held in the application. A screen is displayed on the user terminal 10 under display control exerted by the server 20.

The initial screen 30 includes a message-display area 31, a photographic-image display area 32, a search-target selection area 33, and a search button 34. The user photographs an article which is to be stored, in accordance with a displayed message. The application execution unit 11 obtains a photographic image of the article which is generated by the user photographing the article in collaboration with the photographing unit 12, and displays the photographic image in the display area 32 (step 101). After photographing the article, the user checks a checkbox to select a search target. In response to this, the application execution unit 11 obtains the selected search target (step 102). In the present exemplary embodiment, storage goods (“items for sale” as described above) or “storage method” for the article may be selected as a search target. After that, in response to the user's selection of the search button 34, the application execution unit 11 transmits the photographic image and the search target to the server 20 to request a search for the search target from the server 20 (step 103).

In the present exemplary embodiment, the user uses the camera of the user terminal 10 to photograph an article by themselves. However, the configuration is not limited to this. The user may select an existing photograph or the like and may use the selected photograph as an image transmitted to the server 20.

In the server 20, the receiving unit 211 receives the search request transmitted from the user terminal 10, and thus obtains the photographic image and the search target (step 201). The article identifying unit 212 analyzes the obtained image to extract the article from the image (step 202). Strictly speaking, the article identifying unit 212 cuts out some object image included in the image, and checks the cut-out image against image data in the article-image information in FIG. 2. Thus, the article identifying unit 212 identifies the photographed article. In the present exemplary embodiment, for simplification of description, this operation is expressed as extraction of an article from an image or identification of an article.

FIG. 6D illustrates an initial screen 30 which displays a photographic image different from that in FIG. 6A. In FIG. 6D, multiple different articles are photographed. If the article identifying unit 212 extracts multiple articles from the image (Y in step 203), the article identifying unit 212 transmits a list of the extracted articles to the user terminal 10 to request selection of an article(s) that is to be stored (step 204). The list of articles (hereinafter referred to as an “article list”) includes the names of the extracted articles.

FIG. 6E illustrates a display example of a selection screen 60 displayed on the user terminal 10 in response to transmission of the article list. After transmission of the search request, the application execution unit 11 waits for reception of a search result. If the application execution unit 11 receives an article list, not a search result (Y in step 104), the application execution unit 11 displays the selection screen 60 including the article list (step 105). The selection screen 60 includes a message-display area 61, an article-list display area 62, and a search button 63. The user checks a corresponding checkbox(es) on the article-list display area 62 in accordance with the displayed message to select an article(s) which is to be stored. After that, in response to the user's selection of the search button 63, the application execution unit 11 notifies the server 20 of the name(s) of the article(s) selected by the user (step 106).

The user may check a checkbox of “all articles”, which is displayed in the article-list display area 62, to select all the photographed articles as storage targets. In the present exemplary embodiment, article names displayed on the selection screen 60 are referred to, and an article(s) that is to be stored is selected. For example, the following user interface may be employed: the photographic image obtained in step 101 or images of articles extracted in step 202 are displayed on the selection screen 60; and images of articles are selected. Since multiple articles of the same type may be photographed, an article(s) that is to be stored is easily selected compared with selection of an article(s) from a list of article names.

The case in which a search result, not an article list, is received (N in step 104) will be described below.

The article identifying unit 212 obtains the article, which is selected by the user, through notification from the user terminal 10 (step 205). The user may select multiple articles. In this case, a search is performed by using the articles as targets, in the search process performed in a later stage.

As described above, when the service providing unit 21 identifies multiple articles from the image obtained in step 201, the service providing unit 21 presents the identified articles to the user, and determines an article(s), which is selected by the user from the presented articles, as an article(s) that is to be stored, that is, a target(s) for display of information useful for storage.

If the user has selected, as a search target, storage goods, that is, items for sale (Y in step 206), the item-for-sale searching unit 213 refers to the item-for-sale information in FIG. 3, and searches for items for sale which are appropriate for the article extracted from the image (step 207). That is, for example, when the article belongs to “bag”, the item-for-sale searching unit 213 searches for items for sale, for each of which the setting items in “article suitable for storage” in the item-for-sale information include “bag”. According to the setting example illustrated in FIG. 3, “bag” is set in “article suitable for storage” of “article A”. The search result includes “article A”. When the user has selected multiple articles, for each article, the item-for-sale searching unit 213 refers to the item-for-sale information, and obtains a search result. When, through the search, the item-for-sale searching unit 213 determines items for sale which are appropriate for storage of the article, the item-for-sale searching unit 213 reads image data of the items for sale from the item-for-sale information, and transmits, to the user terminal 10, the read image data as a search result (step 208).

In the case where the search target is set to storage goods, that is, items for sale (“goods” in step 107), when the application execution unit 11 receives the search result transmitted from the server 20 in response to the search request (step 108), the application execution unit 11 displays the received search result on the user terminal 10 (step 109). FIG. 6B illustrates a display example of a search-result display screen 40 for displaying a search result.

The search-result display screen 40 includes a search-result display area 41, a filtering button 42, and a storage-method search button 43. The user may refer to the search-result display screen 40 to know an item for sale which is appropriate for storage of the photographed article. When multiple items for sale are obtained as a search result, the user may scroll, for display, the search result in the display area 41 (in the presented exemplary embodiment, the entire display area of the touch panel) by using a predetermined operation such as a swipe.

In the present exemplary embodiment, a function of filtering a search result is provided. When the user wants to filter the search result, the user selects the filtering button 42. If selection of the filtering button 42 has been detected (Y in step 110), the application execution unit 11 displays a filtering screen 70 for setting a filtering condition. For example, the application execution unit 11 notifies the server 20 of selection of the filtering button 42. In response to the notification, the item-for-sale searching unit 213 refers to the item-for-sale information to generate the filtering screen 70 which is transmitted to the user terminal 10. Thus, after reception of the user's filtering request, the server 20 may generate the filtering screen 70 for asking the user a filtering condition for filtering items for sale on the basis of the item-for-sale information.

FIG. 6F illustrates a display example of the filtering screen 70 according to the present exemplary embodiment. In the present exemplary embodiment, the user is allowed to specify, as a filtering condition, a condition related to a location for use of an item for sale. Examples of a location for use of an item for sale include a Japanese-style closet, an existing shelf, a wall for arranging the article by hanging the article on a hook or the like. When, as in the present exemplary embodiment, an article is arranged through storage, a location for use of an item for sale may be a storage location. In addition, other than a location for use of an item for sale, the user may specify the specification, features, or the like of an item for sale, if the user wants, so that items for sale which are presented in step 108 are filtered.

The filtering screen 70 includes an image-acquisition specifying area 71 for specifying the way of acquiring an image for identifying a location, an image display area 72, an additional-condition specifying area 73, and an OK button 74. In the present exemplary embodiment, a location, which serves as a filtering condition for filtering items for sale, for use of an item for sale is identified from an image. Therefore, when the user has already photographed a location for use of an item for sale, and wants to use the image in the image-acquisition specifying area 71, the user checks a checkbox corresponding to “Select an image of the location”. When the user is going to photograph a location for use of an item for sale, the user checks a checkbox corresponding to “Photograph the location”. When the user selects an existing image or photographs a location, the image is displayed in the display area 72.

When the user wants to specify an additional filtering condition (hereinafter also referred to as an “additional condition”) for filtering items for sale, the user checks a checkbox(es) corresponding to a condition(s) displayed in the additional-condition specifying area 73. A list of conditions, with which a filtering operation is allowed to be performed, is displayed in the additional-condition specifying area 73. FIG. 6F illustrates an example in which a filtering operation may be performed with “size” and “color”. Specifically, “size” indicates a condition about the size of an item for sale and the size of an area of a location for use of an item for sale. The condition causes the items for sale to be filtered to items for sale, each of which may be accommodated in the location. “Color” indicates a condition about a difference in hue between an item for sale and a location for use of an item for sale. This condition indicates that the color of an item for sale is not necessarily the same as that of a location for use of an item for sale. This condition causes the items for sale to be filtered to items for sale, whose hues are harmonious with that of the location and each of which is accommodated for use in the location without a strange feeling. In this example, the term, “color”, is used. Alternatively, as in setting in the item-for-sale information, “style” may be used as a filtering condition in a similar manner of “color”.

Conditions, which may be used in a filtering operation, may be extracted by referring to the informational fields of the item-for-sale information. In the present exemplary embodiment, additional conditions are set on the basis of the item-for-sale information in FIG. 3 so that a filtering operation may be performed with the condition of size and the condition of color. Further, to perform a filtering operation with a desired keyword, a keyword input area 73-1 is provided in the additional-condition specifying area 73 in the present exemplary embodiment. In response to the user specifying a filtering condition on the filtering screen 70 and then selecting the OK button 74, the application execution unit 11 receives the filtering condition specified by the user (step 111), and transmits the filtering condition to the server 20 (step 112)

If the server 20 receives the filtering condition (Y in step 210), the item-for-sale searching unit 213 analyzes the image, included in the filtering condition, to identify the photographed storage location for an item for sale (step 211). More specifically, the item-for-sale searching unit 213 cuts out some object image, included in the image, to check the cut-out image against image data in the storage-location image information in FIG. 4. Thus, the item-for-sale searching unit 213 identifies the storage location included in the image.

When the item-for-sale searching unit 213 identifies the storage location, the item-for-sale searching unit 213 refers to the item-for-sale information in FIG. 3, and filters the items for sale, which are obtained through the search in step 207, to items for sale which are appropriate for the storage location extracted from the image (step 212). That is, for example, when the storage location belongs to “Japanese-style closet”, the item-for-sale searching unit 213 searches the items for sale, which are extracted in step 207, for items for sale, for each of which the setting items in “appropriate location for placement of item for sale” of the item-for-sale information include “Japanese-style closet”. According to the setting example illustrated in FIG. 3, among the items for sale which are extracted in step 207, “Japanese-style closet” is included in the setting items in “appropriate location for placement of item for sale” of “article A”. Thus, “article A” is included in the search result. If “article B” is extracted in step 207, “Japanese-style closet” is not included in the setting items in “appropriate location for placement of item for sale” of “article B”. Thus, as a result of a filtering operation, “article B” is not included in the search result. The item-for-sale searching unit 213 performs a filtering operation, as described above, to determine items for sale for which information is to be provided. Then, the item-for-sale searching unit 213 reads image data of the items for sale from the item-for-sale information, and transmits, to user terminal 10, the read image data which is displayed as a search result after the filtering operation (step 213).

In the case where a filtering operation is requested on the search-result display screen 40 in FIG. 6B, when the application execution unit 11 receives the search result which is obtained after the filtering operation and which is transmitted from the server 20 in response to the request (step 113), the application execution unit 11 displays the received search result on the user terminal 10 (step 114). The search-result display screen 40 for displaying a search result obtained after a filtering operation may be the same as that in FIG. 6B.

In the present exemplary embodiment, the fact that the server 20 does not receive a filtering condition indicates that the server 20 has received a search request for a storage method. In this case (N in step 210), the process proceeds to step 215. In contrast, the fact that the user of the user terminal 10 does not use the filtering operation on the search-result display screen 40, that is, the fact that the user does not select the filtering button 42 indicates that the user requests a search for a storage method, that is, selects the storage-method search button 43. In this case (N in step 110), the process proceeds to step 116.

Therefore, in the state in which the search-result display screen 40 in FIG. 6B is displayed on the user terminal 10, if the user selects the storage-method search button 43 (N in step 110), the application execution unit 11 requests a search for a storage method from the server 20 (step 115).

When, in the server 20, the receiving unit 211 receives a search request for a storage method (step 214), the storage-method searching unit 214 searches for a storage method by using a search engine (step 215). In the search, in addition to a predetermined keyword such as “storage”, the storage-method searching unit 214 specifies, as keywords, the name of an article such as “bag”, the name of an item for sale such as “article A”, and a word indicating a storage location such as “Japanese-style closet”, which are determined in the process described above, and performs a Web search. A Web search may be performed by using either one or both of an article and an item for sale as a keyword(s). Additionally, the user may specify, on a screen, a keyword for a search for a storage method (not illustrated).

In the case where the storage-method searching unit 214 searches for a storage method, the keyword configuration is different between the case of a transition from FIG. 6B to FIG. 6C and the case of a transition from FIG. 6A to FIG. 6C, that is, the case in which storage method has been selected as a search target on the initial screen 30. That is, if storage method has been selected as a search target on the initial screen 30 (N in step 206), since information about items for sale and a storage location has not been obtained, the storage-method searching unit 214 performs a Web search without keywords about items for sale and a storage location. The storage-method searching unit 214 transmits, to the user terminal 10, the search result, which is obtained from the Web search with keywords, as information about a storage method (step 216).

When the application execution unit 11 receives a search result for a storage method (step 116), the application execution unit 11 displays the received search result on the user terminal 10 (step 117). FIG. 6C illustrates a display example of a search-result display screen 50 for displaying a search result.

The search-result display screen 50 includes a search-result display area 51, a “Back to initial screen” button 52, and an end button 53. The user may refer to the search-result display screen 50 to know a storage method appropriate for storage of the article that is to be stored. When multiple storage methods are obtained as a search result, the user may scroll the search result in the display area 51 (in the present exemplary embodiment, the entire display area of the touch panel) by using a predetermined operation such as a swipe.

After that, if the user's selection of the “Back to the initial screen” button 52 has been detected (N in step 118), the application execution unit 11 displays the initial screen 30. In contrast, if the user's selection of the end button 53 has been detected (Y in step 118), the application execution unit 11 ends the process.

The application execution unit 11 notifies the server 20 of which button, the button 52 or the button 53 on the search-result display screen 50, has been selected by the user. If the service providing unit 21 of the server 20 receives a notification indicating that the user has selected the “Back to initial screen” button 52 (N in step 217), the process proceeds to step 201. In contrast, if the service providing unit 21 receives a notification indicating that the user has selected the end button 53 (Y in step 217), the process ends.

As described above, the present exemplary embodiment enables an item for sale appropriate for storage of a photographed article or a storage method for the article to be proposed to a user as arrangement-related information which is useful for arranging the photographed article.

In recent years, not a few users make, by themselves, storage goods used in storage of articles, that is, do so-called Do It Yourself (DIY). In view of this, information about DIY may be provided to a user as arrangement-related information. In this case, for example, a search target such as “DIY search” is added to the initial screen 30. Alternatively, “DIY search” may be selected on the search-result display screen 40 in FIG. 6B or the filtering screen 70 in FIG. 6F. On reception of a notification indicating a user's selection of “DIY search”, the storage-method searching unit 214 performs a Web search by using keywords of “DIY”, the name of an article, and the like. Thus, instead of an item for sale for storage of an article, a user may be provided with information useful for making storage goods for the article through DIY.

In the present exemplary embodiment, the size and weight of an article that is to be stored in an item for sale are not particularly referred to. To determine an item for sale which accommodates the article for sure, these types of information may be needed. Therefore, in a search for an item for sale, the service providing unit 21 may obtain, from the user terminal 10, information about the size and the like of an article, and may more reliably extract an item for sale which is appropriate for storage of the article.

In the embodiments above, the term “processor” refers to hardware in a broad sense. Examples of the processor include general processors (e.g., CPU) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing apparatus comprising:
a processor configured to:
   obtain an image provided from a user;
   identify an article in the image; and
   exert control to display arrangement-related information useful for arranging the identified article.
      (((2)))

The information processing apparatus according to (((1))),
wherein the arrangement-related information includes information about a product used to arrange the article.
   (((3)))

The information processing apparatus according to (((2))),
wherein the processor is configured to:
   ask the user a condition related to a location for use of the product; and
   in accordance with the location for use which is specified in response to the asking, exert control to display the information about the product.
      (((4)))

The information processing apparatus according to (((2))),
wherein the processor is configured to:
   ask the user a condition related to a size of the product and a size of an area which serves as a location for use of the product; and
   in accordance with the size of the area specified in response to the asking, exert control to display the information about the product.
      (((5)))

The information processing apparatus according to (((2))),
wherein the processor is configured to:
   ask the user a condition related to a difference in hue between the product and a location for use of the product; and
   in accordance with the difference in hue from the location for use which is specified in response to the asking, exert control to display the information about the product.
      (((6)))

The information processing apparatus according to (((2))),
wherein the information about the product used to arrange the article is information useful for making, by the user themselves, goods-for-arrangement used to arrange the identified article.
   (((7)))

The information processing apparatus according to (((1))),
wherein the processor is configured to:
   when a plurality of articles are identified from the image, present the identified articles to the user; and
   specify, as a target of display of the information useful for arrangement, an article selected by the user from the presented articles.
      (((8)))

The information processing apparatus according to (((1))) or (((2))),
wherein the arrangement-related information includes information about a method of arranging the article.
   (((9)))

The information processing apparatus according to (((8))),
wherein the processor is configured to:
   provide, to the user, a result from a Web search as the arrangement-related information, the Web search being performed on a basis of a word for specifying either one or both of the identified article and a product used to arrange the article.
      (((10)))

A program causing a computer to execute a process comprising:
obtaining an image provided from a user;
identifying an article in the image; and
exerting control to display arrangement-related information useful for arranging the identified article.

What is claimed is:

1. An information processing apparatus comprising:
a processor configured to:
obtain an image provided from a user;
identify an article in the image; and
exert control to display arrangement-related information useful for arranging the identified article.

2. The information processing apparatus according to claim 1,
wherein the arrangement-related information includes information about a product used to arrange the article.

3. The information processing apparatus according to claim 2,
wherein the processor is configured to:
ask the user a condition related to a location for use of the product; and
in accordance with the location for use which is specified in response to the asking, exert control to display the information about the product.

4. The information processing apparatus according to claim 2,
wherein the processor is configured to:
ask the user a condition related to a size of the product and a size of an area which serves as a location for use of the product; and
in accordance with the size of the area specified in response to the asking, exert control to display the information about the product.

5. The information processing apparatus according to claim 2,
wherein the processor is configured to:
ask the user a condition related to a difference in hue between the product and a location for use of the product; and
in accordance with the difference in hue from the location for use which is specified in response to the asking, exert control to display the information about the product.

6. The information processing apparatus according to claim 2,
wherein the information about the product used to arrange the article is information useful for making, by the user themselves, goods-for-arrangement used to arrange the identified article.

7. The information processing apparatus according to claim 1,
wherein the processor is configured to:
when a plurality of articles are identified from the image, present the identified articles to the user; and
specify, as a target of display of the information useful for arrangement, an article selected by the user from the presented articles.

8. The information processing apparatus according to claim 1,
wherein the arrangement-related information includes information about a method of arranging the article.

9. The information processing apparatus according to claim 2,
wherein the arrangement-related information includes information about a method of arranging the article.

10. The information processing apparatus according to claim 8,
wherein the processor is configured to:
provide, to the user, a result from a Web search as the arrangement-related information, the Web search being performed on a basis of a word for specifying either one or both of the identified article and a product used to arrange the article.

11. The information processing apparatus according to claim 9,
wherein the processor is configured to:
provide, to the user, a result from a Web search as the arrangement-related information, the Web search being performed on a basis of a word for specifying either one or both of the identified article and the product used to arrange the article.

12. A non-transitory computer readable medium storing a program causing a computer to execute a process comprising:
obtaining an image provided from a user;
identifying an article in the image; and
exerting control to display arrangement-related information useful for arranging the identified article.

13. An information processing method comprising:
obtaining an image provided from a user;
identifying an article in the image; and
exerting control to display arrangement-related information useful for arranging the identified article.
